(19) United States
(12) Patent Application Publication
(10) Pub. No.: US 2019/0186314 A1
(43) Pub. Date: Jun. 20, 2019

(54) OXIDATION CATALYST COMPRISING SULFUR COMPOUND

(71) Applicant: BASF Corporation, Florham Park, NJ (US)

(72) Inventors: Shiang Sung, New York, NY (US); Joseph A. Patchett, Basking Ridge, NJ (US)

(21) Appl. No.: 16/323,059

(22) PCT Filed: Aug. 2, 2017
(86) PCT No.: PCT/IB2017/054739

§ 371 Date: Feb. 4, 2019

Related U.S. Application Data
(60) Provisional application No. 62/371,001, filed on Aug. 4, 2016.

(51) Int. Cl. F01N 3/023; F01N 3/10; F01N 3/20; F01N 3/035; B01J 21/04; B01J 23/44; B01J 27/045; B01J 29/06; B01J 37/02; B01J 37/20

(52) U.S. Cl. CPC F01N 3/0231; F01N 2510/0684; F01N 3/2066; F01N 3/035; B01J 21/04; B01J 23/44; B01J 27/045; B01J 29/06; B01J 37/0205; B01J 37/0207; B01J 37/0246; B01J 37/0248; B01J 37/20; F01N 2510/063; F01N 3/101

(57) ABSTRACT

A diesel oxidation catalyst article is provided, which includes a substrate carrier having a plurality of channels adapted for gas flow and a catalyst composition positioned to contact an exhaust gas passing through each channel. The catalyst composition includes a platinum (Pt) component and a sulfur (S)-containing component impregnated onto a refractory metal oxide support and is effective to abate hydrocarbon and carbon monoxide, as well as oxidize NO to NO₂ in the exhaust gas. Methods of making and using the catalyst article are also provided, as well as emission treatment systems comprising the catalyst article.

### FIELD OF THE INVENTION

The present invention relates to oxidation catalyst compositions, catalyst articles coated with such compositions, emission treatment systems comprising such catalyst articles, and methods of use thereof. Such oxidation catalyst compositions are particularly useful in the oxidation of nitrogen oxides to form nitrogen dioxide used in passive soot-burn regeneration methods.

### BACKGROUND OF THE INVENTION

Emissions of internal combustion engines include particulate matter (PM), nitrogen oxides (NOₓ), unburned hydrocarbons (HC), and carbon monoxide (CO). The term NOₓ is used to describe various chemical species of nitrogen oxides, including nitrogen monoxide (NO) and nitrogen dioxide (NO₂). The two major components of exhaust particulate matter are the soluble organic fraction (SOF) and the soot fraction. The SOF condenses on the soot in layers, and is generally derived from unburned fuel and lubricating oils. While the SOF can exist in the exhaust gas either as a vapor or as an aerosol (i.e., fine droplets of liquid condensate), depending on the temperature of the exhaust gas, soot is a solid material predominately composed of particles of carbon.

Generally, particulate matter (including the SOF and soot) can be removed from the exhaust gas stream using a filtering device called a Diesel Particulate Filter (DPF). The filter material, traps soot, thereby removing the soot from the exhaust gas stream and the soot buildup in DPFs must be periodically removed if it is not removed according to the manufacturers' recommendations, it will plug the DPF and cause serious engine damage. The process of cleaning the filter is referred to as regeneration. Filter regeneration requires exposures to temperatures that may be higher than temperatures normally encountered during engine operation.

Exposure to such high temperatures over prolonged periods of time will generally result in changes of the structure and catalytic performance of catalyst compositions present in various components of the exhaust gas treatment system. Typically, high temperature exposure has been associated with metal agglomeration and structural transition of support materials present in catalyst compositions, leading to a decrease in catalytic surface area and deactivation. As such, filter regeneration protocols at lower temperatures are highly desirable.

One way to lower filter regeneration temperatures is by oxidizing some of the existing NO in the exhaust to NO2. For example, after-treatment systems of diesel engines often include an oxidation catalyst, which not only oxidizes CO and HC, but also converts NO into NO₂, which is a suitable oxidant to burn the soot trapped by the DPF. Such NO₂ based regeneration is typically conducted at low temperatures in the presence of increased NO₂ concentration, which is produced via catalytic oxidation of NO (i.e., by increasing the NO₂:NO ratio in NOₓ). This method of filter regeneration using generated NO₂ is rapidly becoming the dominant regeneration mechanism in most catalytic gas exhaust treatment systems.

Generally, these types of oxidation catalysts comprise a precious metal, such as a platinum group metal (PGM), dispersed on a refractory metal oxide support, such as alumina, known for treating exhaust gas of diesel engines in order to convert both HC and CO gaseous pollutants by catalyzing the oxidation of these pollutants to carbon dioxide (CO₂) and water (H₂O) and promoting the oxidation of NO to NO₂.

These observations, in conjunction with emissions regulations becoming more stringent, have driven the need for developing emission gas treatment systems with improved NO to NO₂ conversion to allow for passive soot-burn regeneration at lower temperatures, thereby prolonging the catalytic activity and longevity of components within such emission gas treatment systems.

### SUMMARY OF THE INVENTION

The present invention provides a diesel oxidation catalyst (DOC) composition suitable for at least partial conversion of gaseous HC and CO emissions as well as partial conversion of NO into NO₂. NO₂ is an important contributor in the nitrogen dioxide based regeneration of trapped soot, where NO₂ is used as an oxidant to burn off trapped soot in a soot filter at low temperatures (i.e., <600° C.). Increased local NO₂ concentrations are required in order to carry out such a nitrogen dioxide based regeneration, which are typically produced by DOC catalyst compositions. The DOC composition described herein comprises a platinum component and a sulfur-containing component impregnated onto the same refractory metal oxide support, wherein the sulfur-containing component contributes to the local production of NO₂.

One aspect of the invention is directed to a catalyst article for abatement of exhaust gas emissions from an engine, comprising a substrate carrier having a plurality of channels adapted for gas flow and a catalyst composition positioned to contact an exhaust gas passing through each channel, wherein the catalyst composition comprises a platinum (Pt) component and a sulfur (S)-containing component impregnated onto a refractory metal oxide support; and wherein the catalyst composition is effective to abate hydrocarbon and carbon monoxide, and to oxidize NO to NO₂ in the exhaust gas.

In some embodiments, the Pt:S molar ratio is in the range of about 1:1 to about 1:5, wherein the amount of the S-containing component is calculated as sulfur dioxide (SO₂). In some embodiments, the catalyst composition is substantially free of palladium. In some embodiments, the catalyst composition further comprises a zeolite. In some embodiments, the S-containing component is present in an amount in the range of about 2 g/ft³ to about 250 g/ft³. In some embodiments, the Pt component is present in an amount in the range of about 2 g/ft³ to about 200 g/ft³.

In some embodiments the S-containing component is present in the range of about 0.1% to about 20% by weight, calculated as sulfur dioxide (SO₂), based on the weight of the impregnated refractory metal oxide support.

In some embodiments, the Pt component is present in the range of about 0.1% to about 10% by weight based on the weight of the impregnated refractory metal oxide support.

In some embodiments, the catalyst composition is in the form of a coating on the substrate carrier with a loading of at least about 0.2 g/in³. In some embodiments, the substrate carrier is a honeycomb. In some embodiments, the substrate carrier comprises a wall flow filter substrate. In some embodiments, the substrate carrier comprises a flow through substrate.

In some embodiments, the refractory metal oxide support comprises alumina, silica, ceria, zirconia, titania, or combinations thereof. In some embodiments, the refractory metal oxide support comprises alumina. In some embodiments, the refractory metal oxide support comprises titania.

In some embodiments, the catalyst article further comprises a second catalyst composition, wherein the second catalyst composition comprises a second refractory metal oxide support, an optional oxygen storage component, and a platinum group metal (PGM) and is substantially free of zeolites; and wherein the second catalyst composition is layered or zoned on the substrate carrier with the catalyst composition of the invention. In some embodiments, the second catalyst composition is disposed directly on the substrate carrier.

Another aspect of the invention is directed to an emission treatment system for treatment of an exhaust gas stream, the emission treatment system comprising an engine producing an exhaust gas stream; and an catalyst article positioned downstream from the engine in fluid communication with the exhaust gas stream and adapted for the abatement of CO and HC and NO to NO₂ conversion.

In some embodiments, the emission treatment system further comprises a soot filter positioned downstream of and immediately adjacent to the catalyst article, wherein the soot filter uses NO₂ produced and released into the treated exhaust gas stream by the oxidation catalyst article for enhanced soot burning. In some embodiments, the soot filter component comprises a soot filter catalyst composition disposed onto a different substrate carrier, wherein said catalyst composition comprises a platinum group metal component impregnated into a refractory metal oxide material or an oxygen storage component.

In some embodiments, the emission treatment system further comprises an SCR catalyst component for the abatement of NOₓ, wherein the SCR catalyst component comprises a metal ion-exchanged molecular sieve and wherein said SCR catalyst component is positioned downstream of the catalyst article and soot filter. In some embodiments, the soot filter component comprises an SCR catalyst composition on a filter substrate, wherein the SCR catalyst composition comprises a metal ion-exchanged molecular sieve. In some embodiments, the engine is a diesel engine.

Another aspect of the invention is directed to a method of making an catalyst article according to the current invention, including: impregnating a refractory metal oxide support with a salt of a platinum component and a sulfur-containing component precursor to form an impregnated refractory metal oxide support; calcining the impregnated refractory metal oxide support; preparing a slurry by mixing the calcined impregnated refractory metal oxide support in an aqueous solution; coating the slurry onto a substrate carrier; and calcining the coated substrate carrier to obtain the catalyst article.

In some embodiments, the impregnating step comprises contacting the refractory metal oxide support with the salt of the platinum component and the sulfur-containing component precursor at the same time. In some embodiments, the impregnating step comprises: contacting the refractory metal oxide support first with the salt of the platinum component followed by contact of the sulfur-containing component precursor; or contacting the refractory metal oxide support first with the sulfur-containing component precursor followed by contact of the salt of the platinum component. In some embodiments, the refractory metal oxide support is alumina. In some embodiments, the sulfur-containing compound is selected from a group consisting of ammonium sulfate, iron sulfate, manganese sulfate, indium sulfate, ammonium sulfide, ammonium persulfate, tin sulfate, and combinations thereof.

The invention includes, without limitation, the following embodiments.

### EMBODIMENT 1

A catalyst article for abatement of exhaust gas emissions from an engine comprising: a substrate carrier having a plurality of channels adapted for gas flow and a catalyst composition positioned to contact an exhaust gas passing through each channel, wherein the catalyst composition comprises a platinum (Pt) component and a sulfur (S)-containing component impregnated onto a refractory metal oxide support; and wherein the catalyst composition is effective to abate hydrocarbon and carbon monoxide, and to oxidize NO to NO₂ in the exhaust gas.

### EMBODIMENT 2

The catalyst article of any preceding or subsequent claim, wherein the Pt component and the sulfur-containing component are present in a Pt:S molar ratio in a range of about 1:1 to about 1:5, and wherein the sulfur-containing component is calculated as sulfur dioxide (SO₂).

### EMBODIMENT 3

The catalyst article of any preceding or subsequent claim, wherein the catalyst composition is substantially free of palladium.

### EMBODIMENT 4

The catalyst article of any preceding or subsequent claim, wherein the catalyst composition further comprises a zeolite.

### EMBODIMENT 5

The catalyst article of any preceding or subsequent claim, wherein the sulfur-containing component, measured as sulfur dioxide (SO₂), is present in an amount in the range of about 2 g/ft³ to about 250 g/ft³ and the Pt component is present in an amount in the range of about 10 g/ft³ to about 200 g/ft³.

### EMBODIMENT 6

The catalyst article of any preceding or subsequent claim, wherein the sulfur-containing component is present in the range of about 0.1% to about 20% by weight, calculated as sulfur dioxide (SO₂), based on the weight of the final impregnated refractory metal oxide support.

### EMBODIMENT 7

The catalyst article of any preceding or subsequent claim, wherein the Pt component is present in the range of about 0.1% to about 10% by weight based on the weight of the impregnated refractory metal oxide support.

### EMBODIMENT 8

The catalyst article of any preceding or subsequent claim, wherein the catalyst composition is in the form of a coating on the substrate carrier with a loading of at least about 1.0 g/in³.

### EMBODIMENT 9

The catalyst article of any preceding or subsequent claim, wherein the substrate carrier is a flow-through substrate or a wall-flow filter substrate.

### EMBODIMENT 10

The catalyst article of any preceding or subsequent claim, wherein the refractory metal oxide support is selected from a group consisting of alumina, silica, ceria, zirconia, titania, and combinations thereof.

### EMBODIMENT 11

The catalyst article of any preceding or subsequent claim, wherein the refractory metal oxide support comprises alumina or titania.

### EMBODIMENT 12

The catalyst article of any preceding or subsequent claim, further comprising a second catalyst composition, wherein the second catalyst composition comprises a second refractory metal oxide support and a platinum group metal (PGM) and is substantially free of zeolites; wherein the second catalyst composition is disposed directly on the substrate carrier in a layered or zoned configuration with the catalyst composition.

### EMBODIMENT 13

The catalyst article of any preceding or subsequent claim, wherein the second catalyst composition further comprises an oxygen storage component.

### EMBODIMENT 14

An emission treatment system for treatment of an exhaust gas stream, the emission treatment system comprising: an engine producing an exhaust gas stream; and a catalyst article of any preceding or subsequent claim positioned downstream from the engine in fluid communication with the exhaust gas stream and adapted for the abatement of CO and HC and NO to NO₂ conversion.

### EMBODIMENT 15

An emission treatment system of any preceding or subsequent claim, further comprising a soot filter component positioned downstream of and immediately adjacent to the catalyst article, wherein the soot filter uses NO₂ produced and released into the treated exhaust gas stream by the catalyst article for enhanced soot burning.

### EMBODIMENT 16

An emission treatment system of any preceding or subsequent claim, wherein the soot filter component comprises a soot filter catalyst composition disposed onto a different substrate carrier, and wherein said soot filter catalyst composition comprises a platinum group metal component impregnated into either a refractory metal oxide material or an oxygen storage component.

### EMBODIMENT 17

An emission treatment system of any preceding or subsequent claim, further comprising an SCR catalyst component for the abatement of NOₓ, wherein the SCR catalyst component comprises a metal ion-exchanged molecular sieve and wherein said SCR catalyst component is positioned downstream of the catalyst article and soot filter component.

### EMBODIMENT 18

An emission treatment system of any preceding or subsequent claim, wherein the soot filter component comprises an SCR catalyst composition on a filter substrate, wherein the SCR catalyst composition comprises a metal ion-exchanged molecular sieve.

### EMBODIMENT 19

An emission treatment system of any preceding or subsequent claim, wherein the engine is a diesel engine.

### EMBODIMENT 20

A method of making a catalyst article of any preceding or subsequent claim comprising: impregnating a refractory metal oxide support with a salt of a platinum component and a sulfur-containing component precursor to form an impregnated refractory metal oxide support; calcining the impregnated refractory metal oxide support; preparing a slurry by mixing the calcined impregnated refractory metal oxide support in an aqueous solution; coating the slurry onto a substrate carrier; and calcining the coated substrate carrier to obtain the catalyst article.

### EMBODIMENT 21

The method of any preceding or subsequent claim, wherein the impregnating step comprises: contacting the refractory metal oxide support with the salt of the platinum component and the sulfur-containing component precursor at the same time; or contacting the refractory metal oxide support first with the salt of the platinum component followed by contact of the sulfur-containing component precursor; or contacting the refractory metal oxide support first with the sulfur-containing component precursor followed by contact of the salt of the platinum component.

### EMBODIMENT 22

The method of any preceding or subsequent claim, wherein the refractory metal oxide support is alumina and the sulfur-containing compound is selected from a group consisting of ammonium sulfate, iron sulfate, manganese sulfate, indium sulfate, ammonium sulfide, ammonium persulfate, tin sulfate, and combinations thereof.

These and other features, aspects, and advantages of the disclosure will be apparent from a reading of the following detailed description together with the accompanying drawings, which are briefly described below. The invention includes any combination of two, three, four, or more of the above-noted embodiments as well as combinations of any two, three, four, or more features or elements set forth in this disclosure, regardless of whether such features or elements are expressly combined in a specific embodiment description herein. This disclosure is intended to be read holistically such that any separable features or elements of the disclosed invention, in any of its various aspects and embodiments, should be viewed as intended to be combinable unless the context clearly dictates otherwise. Other aspects and advantages of the present invention will become apparent from the following.

### BRIEF DESCRIPTION OF THE DRAWINGS

In order to provide an understanding of embodiments of the invention, reference is made to the appended drawings, which are not necessarily drawn to scale, and in which reference numerals refer to components of exemplary embodiments of the invention. The drawings are exemplary only, and should not be construed as limiting the invention.

FIG. 1 is a perspective view of a honeycomb-type substrate carrier which may comprise a diesel oxidation catalyst (DOC) washcoat composition in accordance with the present invention;

FIG. 2 is a partial cross-sectional view enlarged relative to FIG. 1 and taken along a plane parallel to the end faces of the substrate carrier of FIG. 1, which shows an enlarged view of a plurality of the gas flow passages shown in FIG. 1;

FIG. 3 is a schematic depiction of an embodiment of an emission treatment system in which a DOC of the present invention is utilized;

FIG. 4 is a bar graph showing NO conversion of fresh DOC catalyst compositions containing a platinum component and a sulfur-containing component and compositions containing a platinum component and no sulfur-containing component;

FIG. 5 is a bar graph showing NO conversion of fresh DOC catalyst compositions containing a platinum component and different sulfur-containing components;

FIG. 6 is a bar graph showing NO conversion of DOC catalyst compositions made from various metal-containing sulfate precursors;

FIG. 7A is a bar graph showing NO conversion of fresh DOC catalyst compositions made from various metal-free sulfate precursors and metal-containing sulfate precursors;

FIG. 7B is a bar graph showing NO conversion of aged DOC catalyst compositions made from various metal-free sulfate precursors and metal-containing sulfate precursors; and

FIG. 8 shows a cross-sectional view of a zoned oxidation catalyst of the present invention.

### DETAILED DESCRIPTION

The present invention now will be described more fully hereinafter. This invention may, however, be embodied in many different forms and should not be construed as limited to the embodiments set forth herein; rather, these embodiments are provided so that this disclosure will be thorough and complete, and will fully convey the scope of the invention to those skilled in the art. As used in this specification and the claims, the singular forms “a,” “an,” and “the” include plural referents unless the context clearly dictates otherwise.

The present invention provides a diesel oxidation catalyst (DOC) composition suitable for at least partial conversion of gaseous HC and CO emissions as well as partial conversion of NO into NO₂. NO₂ is an important contributor in the nitrogen dioxide based regeneration of trapped soot, where NO₂ is used as an oxidant to burn off the trapped soot in the soot filter at low temperatures (i.e., <600° C.). However, in order to carry out such a NO₂ based regeneration, increased local NO₂ concentrations are required, which can typically be produced by DOC catalyst compositions. The DOC composition described herein comprises a platinum component and a sulfur-containing component impregnated onto the same refractory metal oxide support. Although not intending to be bound by theory, it is believed that the presence of a sulfur-containing component promotes the catalytic activity of the platinum component toward oxidation of NO to NO₂. As such, these sulfur-containing DOC compositions provide increased local concentrations of NO₂, which allowed for passive soot-burn at lower temperature.

The following terms shall have, for the purposes of this application, the respective meanings set forth below.

As used herein, the term “catalyst” or “catalyst composition” refers to a material that promotes a reaction. As used herein, the phrase “catalyst system” refers to a combination of two or more catalysts, for example, a combination of a diesel oxidation catalyst (DOC) and a catalytic soot filter (CSF) catalyst. The catalyst system may be in the form of a washcoat in which the two catalysts are mixed together.

As used herein, the term “SCRoF catalyst component” refers to a material that comprises an SCR catalyst composition deposited onto a soot filter.

As used herein, the term “stream” broadly refers to any combination of flowing gas that may contain solid or liquid particulate matter. The term “gaseous stream” or “exhaust gas stream” means a stream of gaseous constituents, such as the exhaust of an engine, which may contain entrained non-gaseous components such as liquid droplets, solid particulates, and the like. The exhaust gas stream of an engine typically further comprises combustion products, products of incomplete combustion, oxides of nitrogen, combustible and/or carbonaceous particulate matter (soot), and un-reacted oxygen and nitrogen.

As used herein, the term “substrate” refers to the monolithic material onto which the catalyst composition is placed. Most commonly, substrates take the form of a honeycomb, with parallel channels separated by thin walls. However, other substrates include foams or solid shapes used to form packed beds. The honeycomb substrate is sufficiently porous to permit the passage of the gas stream being treated.

As used herein, the term “washcoat” has its usual meaning in the art of a thin, adherent coating of a catalytic or other material applied to a substrate material, such as a honeycomb-type substrate. A washcoat is formed by preparing slurry containing a certain solid content (e.g., 30-90% by weight) of particles in a liquid vehicle, which is then coated onto the substrate and dried to provide a washcoat layer.

As used herein, the term “catalytic article” refers to an element that is used to promote a desired reaction. For example, a catalytic article may comprise a washcoat containing catalytic compositions on a substrate.

As used herein, the term “substantially free” means that there is generally less than about 1 wt. %, including less than about 0.75 wt. %, less than about 0.5 wt. %, less than about 0.25 wt. %, or less than about 0.1 wt. %, of the referenced component e.g., metal (e.g., PGM) or other materials (e.g., zeolite, sulfur-containing compound) in the catalyst composition. In some embodiments, no such component has been intentionally added to the catalyst or washcoat composition. In some embodiments, “substantially free of Pd” includes “free of Pd.” Likewise, “substantially free of sulfur-containing compounds” includes “free of sulfur-containing compounds.” It will be appreciated by one of skill in the art, however that during loading/coating, trace amounts of such components may migrate from one washcoat to another, such that trace amounts of such components can be present in the washcoat of the catalyst composition.

The term “abate” means to decrease in amount and “abatement” means a decrease in the amount, caused by any means.

As used herein, “impregnated” or “impregnation” refers to permeation of the catalytic material into the porous structure of the support material. For example, a DOC composition can be prepared using incipient wetness impregnation techniques and coated onto a catalyst substrate using a washcoat technique as set forth more fully below.

### Catalyst Composition

The DOC catalyst composition includes a platinum (Pt) component and a sulfur (S)-containing component impregnated on a refractory metal oxide support. The platinum component comprises any platinum metal-containing compound, complex, or the like which, upon calcination or use of the catalyst decomposes or otherwise converts to a catalytically active form, usually the metal or the metal oxide. The concentration of the Pt component can vary, but will typically be from about 0.1 wt. % to about 10 wt. % relative to the weight of the impregnated refractory metal oxide support.

In some embodiments, the DOC composition includes additional platinum group metals (PGMs) selected from palladium (Pd), ruthenium (Ru), rhodium (Rh), osmium (Os), iridium (Ir), and mixtures thereof. In some embodiments, the DOC composition is substantially free of palladium. In some embodiments, the DOC catalyst composition further comprises a zeolite.

The sulfur-containing component comprises any sulfur-containing compound, complex, or the like. The concentration of the S-containing component can vary, but will typically be from about 0.1 wt. % to about 20 wt. % relative to the weight of the impregnated refractory metal oxide support. In some embodiments, the sulfur-containing component includes, but is not limited to, sulfates, disulfates, sulfides, persulfates, and combinations thereof.

In some embodiments, the Pt component and S-containing component are present in a molar ratio of about 1:10 to about 10:1, preferably from about 1:1 to about 1:5.

In some embodiments, the Pt and S-containing components are impregnated onto the same refractory metal oxide support. In some embodiments, the Pt and S-containing components are impregnated onto different refractory metal oxide supports.

As used herein, “refractory metal oxide support” refers to metal-containing oxide materials exhibiting chemical and physical stability at high temperatures, such as the temperatures associated with diesel engine exhaust. Exemplary refractory metal oxides include alumina, silica, zirconia, titania, ceria, and physical mixtures or chemical combinations thereof, including atomically-doped combinations and including high surface area or activated compounds such as activated alumina. Exemplary combinations of metal oxides include alumina-zirconia, ceria-zirconia, alumina-ceria-zirconia, lanthana-alumina, lanthana-zirconia-alumina, baria-alumina, baria lanthana-alumina, baria lanthana-neodymia alumina, and alumina-ceria. Exemplary aluminas include large pore boehmite, gamma-alumina, and delta/theta alumina. Useful commercial aluminas include activated aluminas, such as high bulk density gamma-alumina, low or medium bulk density large pore gamma-alumina, and low bulk density large pore boehmite and gamma-alumina.

High surface area refractory metal oxide supports, such as alumina support materials, also referred to as “gamma alumina” or “activated alumina,” typically exhibit a BET surface area in excess of 60 m²/g, often up to about 200 m²/g or higher. Such activated alumina is usually a mixture of the gamma and delta phases of alumina, but may also contain substantial amounts of eta, kappa and theta alumina phases. “BET surface area” has its usual meaning of referring to the Brunauer, Emmett, Teller method for determining surface area by N₂ adsorption. Desirably, the active alumina has a specific surface area of 60 to 350 m²/g, and typically 90 to 250 m²/g.

In some embodiments, the refractory metal oxide may contain sulfur, independent of the 5-containing component included in the catalyst composition as described herein. Examples of refractory metal oxide supports containing sulfur include titania, alumina. In further examples, various grades of titania may contain various amount of sulfur and may also be sulfur free. The amount of sulfur present in the refractory metal oxide support can vary, but will typically be from about 0.1 wt. % to about 3 wt. % relative to the weight of the refractory metal oxide support, measured as SO₂, S, or a combination thereof.

In some embodiments, the combined amount of sulfur present in the refractory metal oxide support and impregnated onto the metal refractory oxide support, ranges from about 0.1 wt. % to about 20 wt. % relative to the weight of the final impregnated refractory metal oxide support. The actual form of S on the refractory support can be in any number of S containing compounds, such as SO₄, SO₃, SO₂, S, or a combination thereof,

In some embodiments, the refractory metal oxide support inherently is substantially sulfur free prior to impregnation with the S-containing compound.

In some embodiments, such catalyst compositions are fresh and in embodiments, such catalyst compositions are aged.

### Substrate

According to one or more embodiments, the substrate for the DOC composition may be constructed of any material typically used for preparing automotive catalysts and will typically comprise a metal or ceramic honeycomb structure. The substrate typically provides a plurality of wall surfaces upon which the DOC washcoat composition is applied and adhered, thereby acting as a carrier for the catalyst composition.

Exemplary metallic substrates include heat resistant metals and metal alloys, such as titanium and stainless steel as well as other alloys in which iron is a substantial or major component. Such alloys may contain one or more of nickel, chromium, and/or aluminum, and the total amount of these metals may advantageously comprise at least 15 wt. % of the alloy, e.g., 10-25 wt. % of chromium, 3-8 wt. % of aluminum, and up to 20 wt. % of nickel. The alloys may also contain small or trace amounts of one or more other metals, such as manganese, copper, vanadium, titanium and the like. The surface of the metal carriers may be oxidized at high temperatures, e.g., 1000° C. and higher, to form an oxide layer on the surface of the substrate, improving the corrosion resistance of the alloy and facilitating adhesion of the washcoat layer to the metal surface.

Ceramic materials used to construct the substrate may include any suitable refractory material, e.g., cordierite, mullite, cordierite-α alumina, silicon nitride, zircon mullite, spodumene, alumina-silica magnesia, zircon silicate, sillimanite, magnesium silicates, zircon, petalite, a alumina, aluminosilicates and the like.

Any suitable substrate may be employed, such as a monolithic flow-through substrate having a plurality of fine, parallel gas flow passages extending from an inlet to an outlet face of the substrate such that the passages are open to fluid flow. The passages, which are essentially straight paths from the inlet to the outlet, are defined by walls on which the catalytic material is coated as a washcoat so that the gases flowing through the passages contact the catalytic material. The flow passages of the monolithic substrate are thin-walled channels which can be of any suitable cross-sectional shape, such as trapezoidal, rectangular, square, sinusoidal, hexagonal, oval, circular, and the like. Such structures may contain from about 60 to about 1200 or more gas inlet openings (i.e., “cells”) per square inch of cross section (cpsi), more usually from about 300 to 600 cpsi. The wall thickness of flow-through substrates can vary, with a typical range being between 0.002 and 0.1 inches. A representative commercially available flow-through substrate is a cordierite substrate having 400 cpsi and a wall thickness of 6 mil, or 600 cpsi and a wall thickness of 4 mil. However, it will be understood that the invention is not limited to a particular substrate type, material, or geometry.

In alternative embodiments, the substrate may be a wall-flow filter substrate, wherein each passage is blocked at one end of the substrate body with a non-porous plug, with alternate passages blocked at opposite end-faces. This requires that gas flow through the porous walls of the wall-flow filter substrate to reach the exit. Such substrates may contain up to about 700 or more cpsi, such as about 100 to 400 cpsi and more typically about 200 to about 300 cpsi. The cross-sectional shape of the cells can vary as described above. Wall-flow filter substrates typically have a wall thickness between 0.002 and 0.1 inches. A representative commercially available wall-flow substrate is constructed from a porous cordierite, an example of which has 200 cpsi and 10 mil wall thickness or 300 cpsi with 8 mil wall thickness, and wall porosity between 45-65%. Other ceramic materials such as aluminum-titanate, silicon carbide and silicon nitride are also used as wall-flow filter substrates. However, it will be understood that the invention is not limited to a particular substrate type, material, or geometry. Note that where the substrate is a wall-flow filter substrate, the DOC composition described herein can permeate into the pore structure of the porous walls (i.e., partially or fully occluding the pore openings) in addition to being disposed on the surface of the walls.

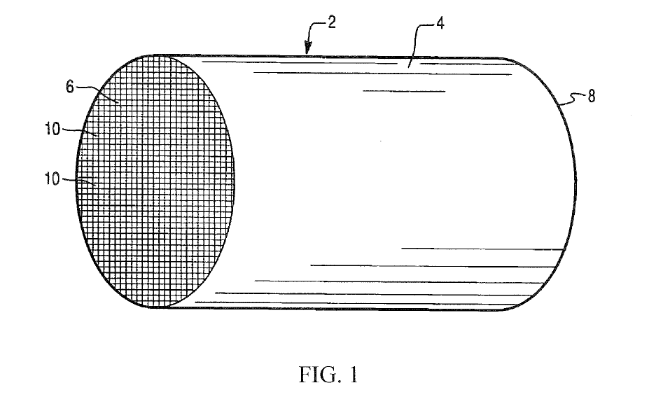

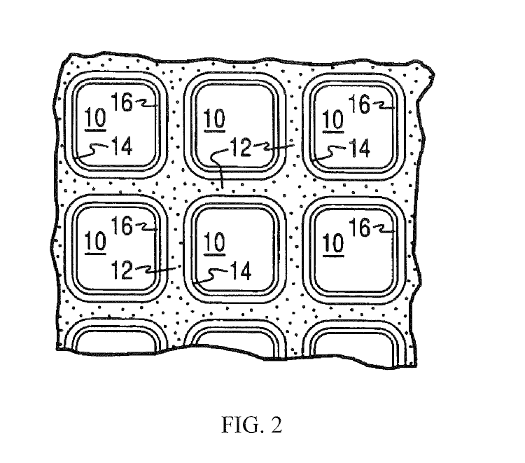

FIGS. 1 and 2 illustrate an exemplary substrate 2 in the form of a flow-through substrate coated with a DOC washcoat composition as described herein. Referring to FIG. 1, the exemplary substrate 2 has a cylindrical shape and a cylindrical outer surface 4, an upstream end face 6 and a corresponding downstream end face 8, which is identical to end face 6. Substrate 2 has a plurality of fine, parallel gas flow passages 10 formed therein. As seen in FIG. 2, flow passages 10 are formed by walls 12 and extend through carrier 2 from upstream end face 6 to downstream end face 8, the passages 10 being unobstructed so as to permit the flow of a fluid, e.g., a gas stream, longitudinally through carrier 2 via gas flow passages 10 thereof. As more easily seen in FIG. 2, walls 12 are so dimensioned and configured that gas flow passages 10 have a substantially regular polygonal shape. As shown, the washcoat composition can be applied in multiple, distinct layers if desired. In the illustrated embodiment, the washcoat consists of both a discrete bottom washcoat layer 14 adhered to the walls 12 of the carrier member and a second discrete top washcoat layer 16 coated over the bottom washcoat layer 14. The present invention can be practiced with one or more (e.g., 2, 3, or 4) washcoat layers and is not limited to the illustrated two-layer embodiment, wherein the DOC catalyst composition can be present in the top layer and/or in the bottom layer.

For example, in one embodiment, a catalyst article comprises multiple layers with each layer having a different composition. The bottom layer (e.g., layer 14 of FIG. 2) can comprise a DOC catalyst composition including a PGM component with substantially free of sulfur-containing component present and the top layer (e.g., layer 16 of FIG. 2) can comprise the DOC catalyst composition of the invention, including a platinum component and a sulfur-containing component, in admixture with one or more of an alumina binder and a zeolite. The relative amount of the DOC catalyst composition in each layer can vary, with an exemplary dual layer coating comprising about 40-90% by weight of the total weight of DOC catalyst composition including a PGM component in the bottom layer (adjacent to the substrate surface) and about 10-60% by weight of the total weight of the disclosed DOC catalyst composition including a PGM component and a S-containing component in the top layer.

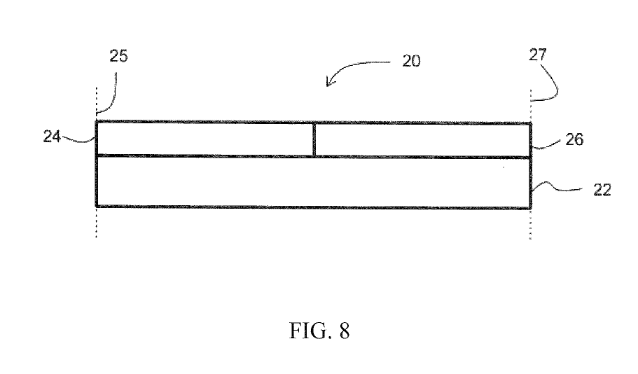

In some embodiments, the same substrate is coated with at least two catalyst compositions contained in separate washcoat slurries in an axially zoned configuration (e.g., zoned onto the same carrier substrate). For example, the same substrate is coated with a washcoat slurry of one catalyst composition and a washcoat slurry of another catalyst composition, wherein each catalyst composition is different. This may be more easily understood by reference to FIG. 8, which shows an embodiment in which the first washcoat zone 24 and the second washcoat zone 26 are located side by side along the length of the carrier substrate 22. The first washcoat zone 24 of specific embodiments extends from the inlet end 25 of the carrier substrate 22 to about 5% to about 95% of the length of the carrier substrate 22. The second washcoat zone 26 extends from the outlet 27 of the carrier substrate 22 to about 5% to about 95% of the total axial length of the carrier substrate 22.

In some embodiments, DOC and CSF catalyst compositions are zoned onto the same carrier substrate. For example referring back to FIG. 8, the first washcoat zone 24 represents the catalyst composition of the DOC composition disclosed herein. The second washcoat zone 26 in such embodiments comprises the CSF component located side by side to zone 24, extending from the outlet 27 of the carrier substrate 22.

In other embodiments, two different DOC catalyst composition are zoned onto the same substrate. For example, the first DOC catalyst composition is a DOC composition according to the current invention and the second DOC catalyst composition comprises a second refractory metal oxide support, a PGM and is substantially free of zeolites and sulfur-containing components, as shown in FIG. 8. In additional embodiments, the same substrate is zoned using three or more different catalyst compositions.

In describing the quantity of washcoat or catalytic metal components or other components of the composition, it is convenient to use units of weight of component per unit volume of carrier substrate. Therefore, the units, grams per cubic inch (“g/in³”) and grams per cubic foot (“g/ft³”), are used herein to mean the weight of a component per volume of the substrate, including the volume of void spaces of the substrate. Other units of weight per volume such as g/L are also sometimes used. The total loading of the DOC composition (including impregnated sulfur-containing component, impregnated Pt component, and support material) on the carrier substrate, such as a monolithic flow-through substrate, is typically from about 0.5 to about 6 g/in³, and more typically from about 1 to about 5 g/in³. Total loading of the Pt component without support material (i.e., platinum component only) is typically in the range of about 2 to about 200 g/ft³. Total loading of the sulfur-containing component without support material (e.g., measured as SO₂ only) is typically in the range of about 2 to about 250 g/ft³. It is noted that these weights per unit volume are typically calculated by weighing the catalyst substrate before and after treatment with the catalyst washcoat composition, and since the treatment process involves drying and calcining the catalyst substrate at high temperature, these weights represent an essentially solvent-free catalyst coating as essentially all of the water of the washcoat slurry has been removed.

### Method of Making DOC Composition

Preparation of the bi component impregnated refractory metal oxide material typically comprises impregnating the refractory metal oxide support material in particulate form with a Pt component precursor and a sulfur-containing component precursor in solution, wherein both precursors are either in the same solution or separate solutions. The platinum component and the sulfur-containing component can be impregnated at the same time or separately, and can be impregnated on the same support particles or separate support particles using an incipient wetness technique.

Incipient wetness impregnation techniques, also called capillary impregnation or dry impregnation, commonly used for the synthesis of heterogeneous materials. Typically, a metal precursor is dissolved in an aqueous or organic solution and then the metal-containing solution is added to a catalyst support, containing the same pore volume as the volume of the solution that was added. Capillary action draws the solution into the pores of the support. Solution added in excess of the support pore volume causes the solution transport to change from a capillary action process to a diffusion process, which is much slower. The catalyst can then be dried and calcined to drive off the volatile components within the solution, depositing the metal on the catalyst surface.

In the preparation of aqueous solutions of the platinum component precursors platinum component salts of the platinum component are used, such as platinum nitrate, tetraammine platinum, platinum chloride, platinum acetate, or combinations thereof.

In the preparation of aqueous solutions of the sulfur-containing component sulfur-containing precursors are used such as ammonium sulfate, iron sulfate, manganese sulfate, indium sulfate, ammonium sulfide, ammonium persulfate, tin sulfate, copper sulfate, magnesium sulfate, or combinations thereof. In some embodiments, the measured aqueous solubility of sulfur-containing component precursors is at least 50 g/100 mL of water.

In some embodiments, the preparation of an impregnated refractory metal oxide support requires an aqueous mixture containing the platinum component precursor, the sulfur-containing component precursor, and the refractory metal oxide support. In such embodiments, both precursors are in contact with the refractory metal oxide support particles at the same time.

In further embodiments, an aqueous solution containing the platinum component precursor and the sulfur-containing component precursor is prepared in advance (such as by pre-mixing both components) prior to contact with the refractory metal oxide support for impregnation.

In other embodiments, the platinum component and the sulfur-containing component are impregnated separately onto the same refractory metal oxide support. For example, in one embodiment, the platinum component is impregnated onto the refractory metal oxide support first to form a platinum impregnated refractory metal oxide support. Such a support can be further modified upon exposure to a solution of a sulfur-containing precursor component to allow additional impregnation of the sulfur-containing component onto the already impregnated refractory metal oxide support to generate the bi component impregnated refractory metal oxide material described herein.

In another embodiment, the sulfur-containing component is first impregnated onto the refractory metal oxide support to form a sulfur-containing component impregnated refractory metal oxide support. This support is further modified upon exposure to a solution of a platinum component precursor to allow additional impregnation of the platinum component onto the already impregnated refractory metal oxide support to generate the bi component impregnated refractory oxide material described herein.

Following treatment of the support particles with the platinum component precursor solution and sulfur-containing component precursor solution or solutions, the impregnated support particles are dried, such as by heat treating the particles at elevated temperature (e.g., 100-150° C.) for a period of time (e.g., 1-3 hours), and then calcining to convert the platinum component and sulfur-containing component to more catalytically active forms. An exemplary calcination process involves heat treatment in air at a temperature of about 400-550° C. for 1-3 hours. The above process can be repeated as needed to reach the desired level of platinum component and sulfur-containing component impregnation. The resulting material can be stored as a dry powder or in slurry form.

### Substrate Coating Process

The above-noted catalyst composition is in the form of carrier particles containing a platinum component and a sulfur-containing component impregnated therein and is mixed generally with water to form a slurry for purposes of coating a catalyst substrate, such as a honeycomb-type substrate. In addition to the catalyst particles, the slurry may optionally contain a binder (e.g., alumina), hydrocarbon (HC) storage components (e.g., zeolites), water-soluble or water-dispersible stabilizers (e.g., barium acetate), promoters (e.g., lanthanum nitrate), associative thickeners, and/or surfactants (including anionic, cationic, non-ionic or amphoteric surfactants). It is advantageous to avoid the addition of acids to the slurry in order to avoid the formation of dissociated platinum ions or related metal species that could lead to alloying within the catalyst material. Accordingly, in certain embodiments, the slurry used to coat the substrate can be substantially or completely acid-free. A typical pH range for the slurry is about 2 to about 4.

Optionally, as noted above, the slurry may contain one or more hydrocarbon (HC) storage component for the adsorption of hydrocarbons (HC). Any known hydrocarbon storage material can be used, e.g., a micro-porous material such as a zeolite or zeolite-like material. Preferably, the hydrocarbon storage material is a zeolite. The zeolite can be a natural or synthetic zeolite such as faujasite, chabazite, clinoptilolite, mordenite, silicalite, zeolite X, zeolite Y, ultrastable zeolite Y, ZSM-5 zeolite, offretite, or a beta zeolite. Preferred zeolite adsorbent materials have a high silica to alumina ratio. The zeolites may have a silica/alumina molar ratio of at least about 25:1, preferably at least about 50:1, with useful ranges of from about 25:1 to 1000:1, 50:1 to 500:1, and about 25:1 to 300:1. Preferred zeolites include ZSM, Y, and beta zeolites. A particularly preferred adsorbent may comprises a beta zeolite of the type disclosed in U.S. Pat. No. 6,171,556, incorporated herein by reference in its entirety. When present, zeolites or other HC storage components are typically used in an amount of about 0.05 g/in³ to about 1 g/in³.

When present, an alumina binder is typically used in an amount of about 0.05 g/in³ to about 1 g/in³. The alumina binder can be, for example, boehmite, gamma-alumina, or delta/theta alumina.

The slurry can be milled to enhance mixing of the particles and formation of a homogenous material. The milling can be accomplished in a ball mill, continuous mill, or other similar equipment, and the solids content of the slurry may be, e.g., about 20-60 wt. %, more particularly about 30-40 wt. %. In one embodiment, the post-milling slurry is characterized by a D₉₀ particle diameter of about 20 to about 30 microns. The D₉₀ is defined as the particle diameter, or equivalent diameter for non-spherical particles, at which about 90% of the particles have a finer particle diameter as typically measured by laser diffraction.

The slurry is then coated on the carrier substrate using a washcoat technique known in the art. In one embodiment, the carrier substrate is dipped one or more times in the slurry or otherwise coated with the slurry. Thereafter, the coated substrate is dried at an elevated temperature (e.g., 100-150° C.) for a period of time (e.g., 1-3 hours) and then calcined by heating, e.g., at 400-600° C., typically for about 10 minutes to about 3 hours. Following drying and calcining, the final washcoat coating layer can be viewed as essentially solvent-free.

After calcining, the catalyst loading can be determined through calculation of the difference in coated and uncoated weights of the substrate. As will be apparent to those of skill in the art, the catalyst loading can be modified by altering the slurry rheology. In addition, the coating/drying/calcining process can be repeated as needed to build the coating to the desired loading level or thickness.

### Emission Treatment System

The present invention also provides an emission treatment system that incorporates the DOC composition described herein. The DOC composition of the present invention is typically used in an integrated emission treatment system comprising one or more additional components for the treatment of diesel exhaust gas emissions. For example, the emission treatment system may further comprise a catalyzed soot filter (CSF) component and/or a selective catalytic reduction (SCR) component. The diesel oxidation catalyst of the invention is typically located upstream from the soot filter and/or selective catalytic reduction component, although the relative placement of the various components of the emission treatment system can be varied. The treatment system can include further components, such as ammonia oxidation materials, additional particulate filtration components, NOₓ storage and/or trapping components, and reductant injectors. The preceding list of components is merely illustrative and should not be taken as limiting the scope of the invention.

The CSF may comprise a substrate coated with a washcoat layer containing one or more catalysts for burning trapped soot and/or oxidizing exhaust gas stream emissions. In general, the soot burning catalyst can be any known catalyst for combustion of soot. For example, the CSF can be catalyzed with one or more high surface area refractory metal oxides (e.g., an alumina or a zirconia oxide) and/or an oxidation catalyst (e.g., a ceria-zirconia) composite for the combustion of unburned hydrocarbons and, to some degree, particulate matter. The soot burning catalyst can be an oxidation catalyst comprising one or more precious metal catalysts (e.g., platinum, palladium, and/or rhodium).

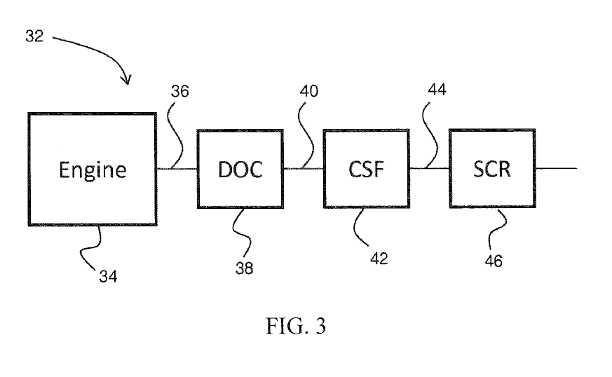

One exemplary emission treatment system is illustrated in FIG. 3. As shown, an exhaust gas stream containing gaseous pollutants and particulate matter is conveyed via exhaust pipe 36 from an engine 34 to a diesel oxidation catalyst (DOC) 38, which comprises the washcoat composition of the present invention. In the DOC 38, unburned gaseous and non-volatile hydrocarbons (i.e., the SOF) and carbon monoxide are largely combusted to form carbon dioxide and water. In addition, a portion of the NO of NOₓ in the exhaust gas stream may be oxidized to NO₂ in the DOC. The exhaust gas stream is next conveyed via exhaust pipe 40 to a catalyzed soot filter (CSF) 42, which traps particulate matter present within the exhaust gas stream. The CSF 42 is optionally catalyzed for passive or active soot regeneration. After removal of particulate matter via CSF 42, the exhaust gas stream is conveyed via exhaust pipe 44 to a downstream selective catalytic reduction (SCR) catalyst component 46 for further treatment and/or conversion of NOₓ.

The DOC 38, does not need to be present as a separate component (such as DOC and CSF) but can be associated with another system component, such as the CSF 42, wherein the catalytic compositions are applied to a single carrier substrate in a zoned or layered configuration.

The DOC 38 may be placed in a close-coupled position. Close-coupled catalysts are placed close to an engine to enable them to reach reaction temperatures as soon as possible. In specific embodiments, the close-coupled catalyst is placed within three feet, more specifically, within one foot of the engine, and even more specifically, less than six inches from the engine. Close-coupled catalysts are often attached directly to the exhaust gas manifold. Due to their close proximity to the engine, close-coupled catalysts are preferably stable at high temperatures.

### EXPERIMENTAL

Aspects of the present invention are more fully illustrated by the following examples, which are set forth to illustrate certain aspects of the present invention and are not to be construed as limiting thereof.

### Example 1: Preparation of Catalyst Reference Sample 1

A high surface area silica-alumina support from a commercial supplier having a BET surface area of about 160 to 200 M²/g and a pore volume of 0.8 to 0.9 cc/g, was impregnated with Pt-amine solution, using standard incipient wetness procedure, with a targeted Pt concentration of 1.1 wt %. The silica-alumina support had about 95% alumina and 5% silica, and no sulfur (S) (i.e. <0.1 wt. %). The Pt impregnated powder was placed in deionized water (solid content 30 wt. %) and the pH was reduced to 2 to 4 by addition of acetic acid, if needed. The slurry was milled to a particle diameter with D₉₀ less than 10 μm, using a ball mill A silica binder was added to the slurry and mixed well.

Next, the milled slurry was coated onto a 1″D×3″L ceramic honeycomb core with a cell density of 400 cell per square inch. The entire ceramic core was submerged into the slurry until no air bubbles remained in the substrate channels. The core was then removed from the slurry and shaken to remove excess slurry out of the core. An air knife was used to blow remaining excess slurry out of the channels until all channels were clear and the core was at the desired weight (determined by solids concentration of the slurry and H₂O adsorption by the substrate). The core was dried at 120° C. for four hours and then put into an oven for calcination in air at 500° C. for an hour. The sample was cooled in air until it reached room temperature.

This coating process was repeated as necessary to achieve the desired loading of 20 g/ft³ Pt.

### Example 2: Preparation of Catalyst Sample 3

A high surface area silica-alumina support from a commercial supplier having a BET surface area of about 160 to 200 M²/g and a pore volume of 0.8 to 0.9 cc/g, was impregnated with ammonium sulfate (NH₄)₂SO₄ solution using standard incipient wetness procedure, with a targeted sulfur concentration of 1.4 wt. %. The silica-alumina support had 95% alumina and 5% silica, and no sulfur (i.e. <0.1 wt. %). The sulfur-impregnated powder was dried at 120° C. for 8 hours. The above dried powder was next impregnated with Pt-amine solution using standard incipient wetness procedure, with a targeted Pt concentration at 1.1 wt. %.

The Pt/Sulfur impregnated powder was placed in deionized water (solid content 30 wt. %) and the pH was reduced to about 2 to 4 by addition of acetic acid, if needed. The slurry was milled to a particle diameter with D₉₀ less than 10 μm, using a ball mill A silica binder was added to the slurry and mixed well.

The milled slurry was coated onto a 1″D×3″L ceramic honeycomb core with a cell density of 400 cell per square inch. The entire ceramic core was submerged into the slurry until no air bubbles remained in the substrate channels. The core was then removed from the slurry and shaken to remove excess slurry out of the core. An air knife was used to blow remaining excess slurry out of the channels until all channels were clear and the core was at the desired weight (determined by solids concentration of the slurry and H₂O adsorption by the substrate). The core was dried at 120° C. for four hours and then put into an oven for calcination in air at 500° C. for an hour. The sample was cooled in air until it reached room temperature.

This coating process was repeated as necessary to achieve the desired loading of 20 g/ft³ Pt.

### Example 3: Preparation of Catalyst Reference Sample 2

A high surface area silica (Si) coated titanium (Ti) support from a commercial supplier having a BET surface area of about 70 to 90 M²/g and a pore volume of 0.8 to 0.9 cc/g, was impregnated with Pt-amine solution. The Si—Ti support has >80% titanium oxide and >15% silica, and no S (i.e. <0.1%). The powder was dried at 120° C. for four hours and then put into an oven for calcination in air at 500° C. for an hour. The sample was cooled in air until it reached room temperature.

The Pt impregnated powder was placed in deionized water (solid content about 40 wt. %). The slurry was milled to a particle diameter with D₉₀ less than 15 μm, using a ball mill. An Al-binder was added into the milled slurry. The final slurry was coated onto a 1″D×3″L ceramic honeycomb core with a cell density of 400 cell per square inch. The entire ceramic core was submerged into the slurry until no air bubbles remained in the substrate channels. The core was then removed from the slurry and shaken to remove excess slurry out of the core. An air knife was used to blow remaining excess slurry out of the channels until all channels were clear and the core was at the desired weight (determined by solids concentration of the slurry and H₂O adsorption by the substrate). The core was dried at 120° C. for an hour and then put into an oven for calcination in air at 500° C. for an hour. The sample was cooled in air until it reached room temperature.

This coating process was repeated as necessary to achieve the desired loading of 20 g/ft³ Pt.

### Example 4: Preparation of Catalyst Sample 4

A high surface area silica coated titanium support from a commercial supplier having a BET surface area of about 70 to 90 M²/g and a pore volume of 0.8 to 0.9 cc/g, was impregnated with ammonium sulfate ((NH₄)₂SO₄.6H₂O) solution, using standard incipient wetness procedure, with a targeted sulfur concentration of about 1 wt. %. The powder was dried at 120° C. for 8 hours. The dried Sulfur/Si—Ti powder was impregnated with a Pt-amine solution. The Pt-impregnated powder was dried at 120° C. for an hour and then put into an oven for calcination in air at 500° C. for an hour. The sample was cooled in air until it reached room temperature.

The Pt impregnated powder was placed in deionized water (solid content about 30 wt. %). The slurry was milled to a particle diameter with D₉₀ less than 15 μm, using a ball mill. An Si-binder was added into the milled slurry. The final slurry was coated onto a 1″D×3″L ceramic honeycomb core with a cell density of 400 cell per square inch. The entire ceramic core was submerged into the slurry until no air bubbles remained in the substrate channels. The core was then removed from the slurry and shaken to remove excess slurry out of the core. An air knife was used to blow remaining excess slurry out of the channels until all channels were clear and the core was at the desired weight (determined by solids concentration of the slurry and H₂O adsorption by the substrate). The core was dried at 120° C. for an hour and then put into an oven for calcination in air at 500° C. for an hour. The sample was cooled in air until it reached room temperature.

This coating process was repeated as necessary to achieve the desired loading of 20 g/ft³ Pt.

### Example 5: Preparation of Catalyst Sample 5

A high surface area silica coated titanium support from a commercial supplier having a BET surface area of about 70 to 90 M²/g and a pore volume of 0.8 to 0.9 cc/g, was impregnated with ammonium peroxydisulfate ((NH₄)₂S₂O₈) solution, using standard incipient wetness procedure, with a targeted sulfur concentration of about 1 wt. %. The sample was dried at 120° C. for 8 hours. The dried S/Si—Ti powder was impregnated with Pt-amine solution. The resulting powder was dried at 120° C. for an hour and then put into an oven for calcination in air at 500° C. for an hour. The sample was cooled in air until it reached room temperature.

The Pt impregnated powder was placed in deionized water (solid content about 30 wt %). The slurry was milled to a particle diameter with D₉₀ less than 15 μm, using a ball mill A Si-binder was added into the milled slurry. The final slurry was coated onto a 1″D×3″L ceramic honeycomb core with a cell density of 400 cell per square inch. The entire ceramic core was submerged into the slurry until no air bubbles remained in the substrate channels. The core was then removed from the slurry and shaken to remove excess slurry out of the core. An air knife was used to blow remaining excess slurry out of the channels until all channels were clear and the core was at the desired weight (determined by solids concentration of the slurry and H₂O adsorption by the substrate). The core was dried at 120° C. for an hour and then put into an oven for calcination in air at 500° C. for an hour. The sample was cooled in air until it reached room temperature.

This coating process was repeated as necessary to achieve the desired loading of 20 g/ft³ Pt.

### Example 6: Preparation of Catalyst Sample 6

A high surface area silica coated titanium support from a commercial supplier having a BET surface area of about 70 to 90 M²/g and a pore volume of 0.8 to 0.9 cc/g, was impregnated with ammonium sulfide((NH₄)₂S) solution, using standard incipient wetness procedure, with a targeted sulfur concentration of about 1 wt. %. The resulting sample was dried at 120° C. for 8 hours. Next, the dried S/Si—Ti powder was impregnated with Pt-amine solution. The powder was dried at 120° C. for an hour and then put into an oven for calcination in air at 500° C. for an hour. The sample was cooled in air until it reached room temperature.

The Pt impregnated powder was placed in deionized water (solid content about 30 wt. %). The slurry was milled to a particle diameter with D₉₀ less than 15 μm, using a ball mill. An Si-binder was added into the milled slurry. The final slurry was coated onto a 1″D×3″L ceramic honeycomb core with a cell density of 400 cell per square inch. The entire ceramic core was submerged into the slurry until no air bubbles remained in the substrate channels. The core was then removed from the slurry and shaken to remove excess slurry out of the core. An air knife was used to blow remaining excess slurry out of the channels until all channels were clear and the core was at the desired weight (determined by solids concentration of the slurry and H₂O adsorption by the substrate). The core was dried at 120° C. for an hour and then put into an oven for calcination in air at 500° C. for an hour. The sample was cooled in air until it reached room temperature.

This coating process can be repeated as necessary to achieve the desired loading of 20 g/ft³ Pt.

### Example 7: Preparation of Catalyst Sample 7

A high surface area silica coated titanium support from a commercial supplier having a BET surface area of about 70 to 90 M²/g and a pore volume of 0.8 to 0.9 cc/g, was impregnated with ammonium sulfate and manganese sulfate ((NH₄)₂SO₄ (MnSO₄)) as a1:1 wt % ratio in solution, using standard incipient wetness procedure, with a targeted sulfur concentration of about 1 wt. %. The sample was dried at 120° C. for 8 hours. The dried S/Si—Ti powder was impregnated with a Pt-amine solution. The resulting powder was dried at 120° C. for an hour and then put into an oven for calcination in air at 500° C. for an hour. The sample was cooled in air until it reached room temperature.

The Pt impregnated powder was placed in deionized water (solid content about 30 wt. %). The slurry was milled to a particle diameter with D₉₀ less than 15 μm, using a ball mill A Si-binder was added into the milled slurry. The final slurry was coated onto a 1″D×3″L ceramic honeycomb core with a cell density of 400 cell per square inch. The entire ceramic core was submerged into the slurry until no air bubbles remained in the substrate channels. The core was then removed from the slurry and shaken to remove excess slurry out of the core. An air knife was used to blow remaining excess slurry out of the channels until all channels were clear and the core was at the desired weight (determined by solids concentration of the slurry and H₂O adsorption by the substrate). The core was dried at 120° C. for an hour and then put into an oven for calcination in air at 500° C. for an hour. The sample was cooled in air until it reached room temperature.

This coating process can be repeated as necessary to achieve the desired loading of 20 g/ft³ Pt.

### Example 8: Preparation of Catalyst Sample 8

A high surface area silica coated titanium support from a commercial supplier having a BET surface area of about 70 to 90 M²/g and a pore volume of 0.8 to 0.9 cc/g, was impregnated with ammonium iron sulfate ((NH₄)₂Fe(SO₄)₂) solution, using standard incipient wetness procedure, with a targeted S concentration of about 1 wt. %. The sample was dried at 120° C. for 8 hours. The dried S/Si—Ti powder was impregnated with a Pt-amine solution. The powder was dried at 120° C. for an hour and then put into an oven for calcination in air at 500° C. for an hour. The sample was cooled in air until it reached room temperature.

The Pt-impregnated powder was placed in deionized water (solid content about 30 wt. %). The slurry was milled to a particle diameter with D₉₀ less than 15 μm, using a ball mill A Si-binder was added into the milled slurry. The final slurry was coated onto a 1″D×3″L ceramic honeycomb core with a cell density of 400 cell per square inch. The entire ceramic core was submerged into the slurry until no air bubbles remained in the substrate channels. The core was then removed from the slurry and shaken to remove excess slurry out of the core. An air knife was used to blow remaining excess slurry out of the channels until all channels were clear and the core was at the desired weight (determined by solids concentration of the slurry and H₂O adsorption by the substrate). The core was dried at 120° C. for an hour and then put into an oven for calcination in air at 500° C. for an hour. The sample was cooled in air until it reached room temperature.

This coating process can be repeated as necessary to achieve the desired loading of 20 g/ft³ Pt.

### Example 9: Preparation of Catalyst Sample 9

A high surface area silica coated titanium support from a commercial supplier having a BET surface area of about 70 to 90 M²/g and a pore volume of 0.8 to 0.9 cc/g, was impregnated with indium sulfate (In₂(SO₄)₃) solution, using standard incipient wetness procedure, with a targeted sulfur concentration of about 1 wt. %. The sample was dried at 120° C. for 8 hours. The dried S/Si—Ti powder was impregnated with a Pt-amine solution. The powder was dried at 120° C. for an hour and then put into an oven for calcination in air at 500° C. for an hour. The sample was cooled in air until it reached room temperature.

The Pt impregnated powder was placed in deionized water (solid content about 30 wt. %). The slurry was milled to a particle diameter with D₉₀ less than 15 μm, using a ball mill A Si-binder was added into the milled slurry. The final slurry was coated onto a 1″D×3″L ceramic honeycomb core with a cell density of 400 cell per square inch. The entire ceramic core was submerged into the slurry until no air bubbles remained in the substrate channels. The core was then removed from the slurry and shaken to remove excess slurry out of the core. An air knife was used to blow remaining excess slurry out of the channels until all channels were clear and the core was at the desired weight (determined by solids concentration of the slurry and H₂O adsorption by the substrate). The core was dried at 120° C. for an hour and then put into an oven for calcination in air at 500° C. for an hour. The sample was cooled in air until it reached room temperature.

This coating process can be repeated as necessary to achieve the desired loading of 20 g/ft³ Pt.

### Example 10: Preparation of Catalyst Reference Sample 10

A high surface area silica-alumina support from a commercial supplier having a BET surface area of about 160 to 200 M²/g and a pore volume of 0.8 to 0.9 cc/g, was impregnated with Pt-amine solution, using standard incipient wetness procedure, with a targeted Pt concentration of 0.6 wt. %. The silica-alumina support had >98% alumina and >1% silica, and no sulfur (i.e. <0.1%). The Pt-impregnated powder was dried at 120° C. and then calcined at 500° C. for one hour.

The Pt impregnated powder was placed in deionized water (solid content 40 wt. %) and the pH was reduced to 4 to 4.5 by addition of acetic acid. The slurry was milled to a particle diameter with D₉₀ less than 10 μm, using a ball mill. An alumina binder was added to the slurry and mixed well.

The milled slurry was coated onto a 1″D×3″L ceramic honeycomb core with a cell density of 400 cell per square inch. The entire ceramic core was submerged into the slurry until no air bubbles remained in the substrate channels. The core was then removed from the slurry and shaken to remove excess slurry out of the core. An air knife was used to blow remaining excess slurry out of the channels until all channels were clear and the core was at the desired weight (determined by solids concentration of the slurry and H₂O adsorption by the substrate).

The core was dried at 120° C. for four hours and then put into an oven for calcination in air at 500° C. for an hour. The sample was cooled in air until it reached room temperature.

This coating process was repeated as necessary to achieve the desired loading of 20 g/ft³ Pt.

### Example 11: Performance Testing of Catalyst Samples 1-10 in Reactor

Test samples were either fresh or aged, wherein fresh samples were tested as is, without further treatment; and aged samples underwent an aging process wherein samples were placed in an engine at an inlet temperature at 550° C. for 100 hours, to simulate the lifetime of a catalyst on a vehicle.

Performance evaluation was carried out, wherein activity measurements were conducted in a reactor under the simulated World Harmonized Transient Cycles (WHTC), with a temperature trace similar to a Euro-5 heavy duty diesel vehicle.

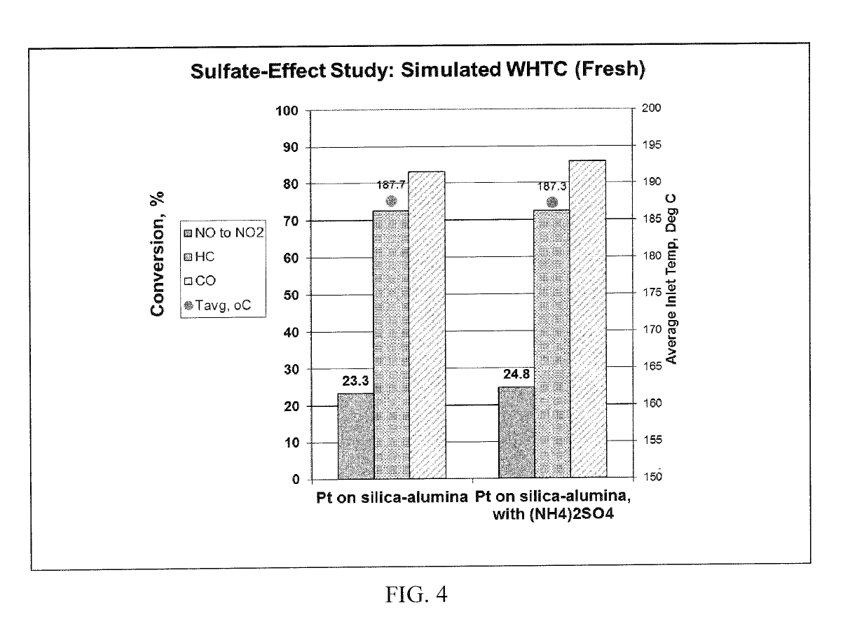

Some results are shown in FIG. 4, wherein data is presented showing a Comparison of fresh samples of Pt on silica-alumina and Pt on silica-alumina with (NH₄)₂SO₄, which illustrates the benefits of (NH₄)₂SO₄ addition onto the Si—Al support.

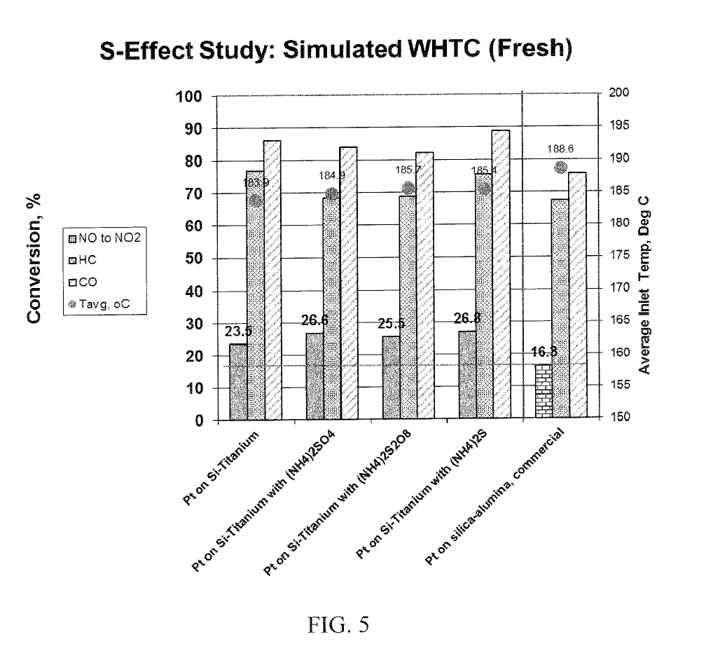

Additional comparison studies in FIG. 5 of catalyst samples having Pt on silica-titanium and Pt on silica-titanium with various sulfur compounds, illustrate that the best sulfur compound is (NH₄)₂S.

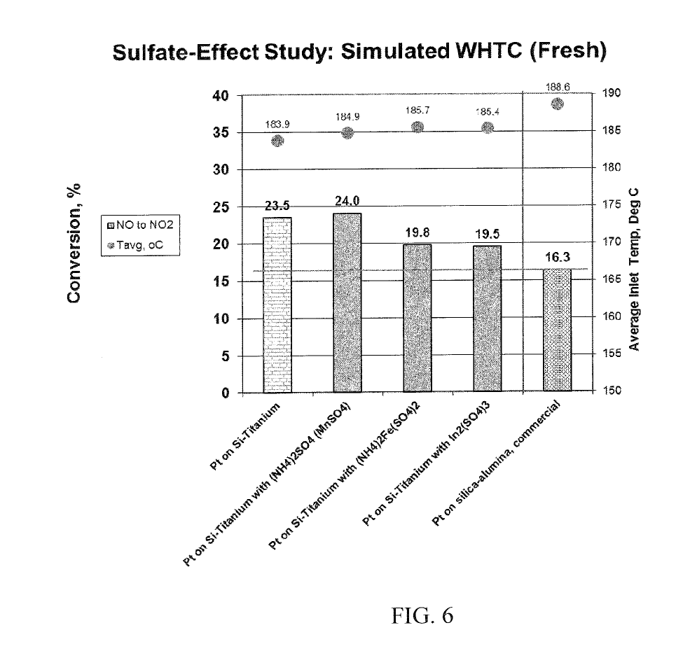

The next examples illustrate the benefit of adding metal-sulfates into the catalysts, to achieve efficient NO₂ performance enhancement. For example, FIG. 6 shows a comparison study of fresh catalyst samples of Pt on silica-titanium and Pt on silica-titanium with Mn, Fe, In-sulfate compounds. The results indicate that only catalyst samples having Mn-sulfate have the potential for NO₂ performance enhancement.

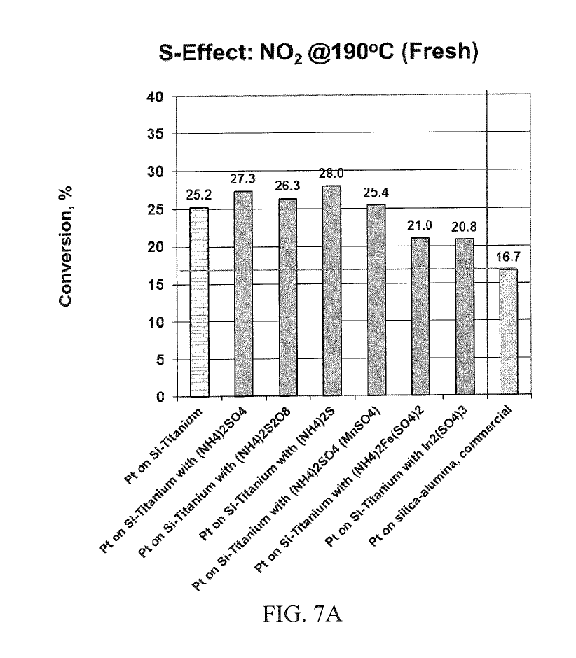

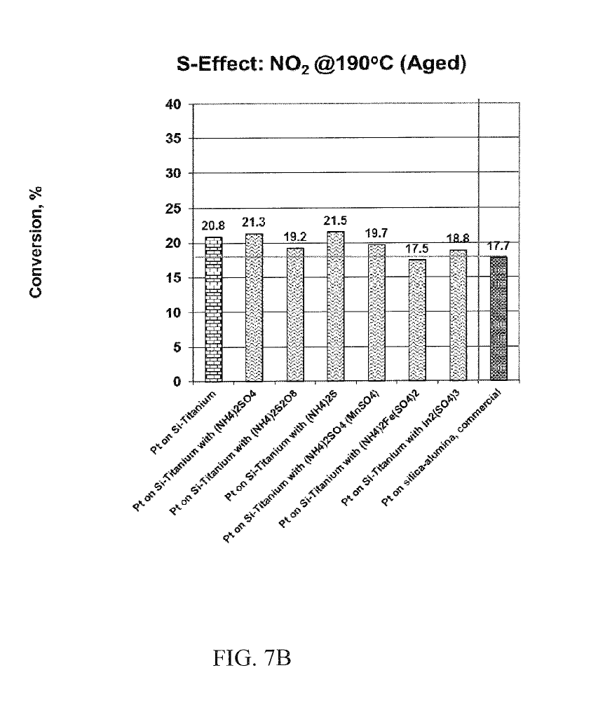

NO₂ values at 190° C. were also studied as the catalyst screening criteria, and FIGS. 7A-8 show the benefits of NO₂ performance enhancement with some S-compounds at 190° C.

FIG. 7A shows data from a comparison study of catalyst samples having Pt on silica-titanium and Pt on silica-titanium with various S-compounds, whereas FIG. 7B shows data of a comparison of aged catalyst samples having Pt on silica-titanium and Pt on silica-titanium with various S-compounds. After aging the samples at 550° C. for 100 hours in an engine dyno, results were similar to the observed results of the fresh samples, although the benefits are smaller.

1. A catalyst article for abatement of exhaust gas emissions from an engine comprising:
a substrate carrier having a plurality of channels adapted for gas flow and a catalyst composition positioned to contact an exhaust gas passing through each channel,
wherein the catalyst composition comprises a platinum (Pt) component and a sulfur (S)-containing component impregnated onto a refractory metal oxide support; and
wherein the catalyst composition is effective to abate hydrocarbon and carbon monoxide, and to oxidize NO to NO₂ in the exhaust gas.

2. The catalyst article of claim 1, wherein the Pt component and the sulfur-containing component are present in a Pt:S molar ratio in a range of about 1:1 to about 1:5, and wherein the sulfur-containing component is calculated as sulfur dioxide (SO₂).

3. The catalyst article of claim 1, wherein the catalyst composition is substantially free of palladium.

4. The catalyst article of claim 1, wherein the catalyst composition further comprises a zeolite.

5. The catalyst article of claim 1, wherein the sulfur-containing component, measured as sulfur dioxide (SO₂), is present in an amount in the range of about 2 g/ft³ to about 250 g/ft³ and the Pt component is present in an amount in the range of about 10 g/ft³ to about 200 g/ft³.

6. The catalyst article of claim 1, wherein the sulfur-containing component is present in the range of about 0.1% to about 20% by weight, calculated as sulfur dioxide (SO₂), based on the weight of the final impregnated refractory metal oxide support.

7. The catalyst article of claim 1, wherein the Pt component is present in the range of about 0.1% to about 10% by weight based on the weight of the impregnated refractory metal oxide support.

8. The catalyst article of claim 1, wherein the catalyst composition is in the form of a coating on the substrate carrier with a loading of at least about 1.0 g/in³.

9. The catalyst article of claim 1, wherein the substrate carrier is a flow-through substrate or a wall-flow filter substrate.

10. The catalyst article of claim 1, wherein the refractory metal oxide support is selected from a group consisting of alumina, silica, ceria, zirconia, titania, and combinations thereof.

11. The catalyst article of claim 1, wherein the refractory metal oxide support comprises alumina or titania.

12. The catalyst article of claim 1, further comprising a second catalyst composition, wherein the second catalyst composition comprises a second refractory metal oxide support and a platinum group metal (PGM) and is substantially free of zeolites; wherein the second catalyst composition is disposed directly on the substrate carrier in a layered or zoned configuration with the catalyst composition.

13. The catalyst article of claim 12, wherein the second catalyst composition further comprises an oxygen storage component.

14. An emission treatment system for treatment of an exhaust gas stream, the emission treatment system comprising:
an engine producing an exhaust gas stream; and
a catalyst article according to claim 1 positioned downstream from the engine in fluid communication with the exhaust gas stream and adapted for the abatement of CO and HC and NO to NO₂ conversion.

15. The emission treatment system of claim 14, further comprising a soot filter component positioned downstream of and immediately adjacent to the catalyst article, wherein the soot filter uses NO₂ produced and released into the treated exhaust gas stream by the catalyst article for enhanced soot burning.

16. The emission treatment system of claim 15, wherein the soot filter component comprises a soot filter catalyst composition disposed onto a different substrate carrier, and wherein said soot filter catalyst composition comprises a platinum group metal component impregnated into either a refractory metal oxide material or an oxygen storage component.

17. The emission treatment system of claim 15, further comprising an SCR catalyst component for the abatement of NOₓ, wherein the SCR catalyst component comprises a metal ion-exchanged molecular sieve and wherein said SCR catalyst component is positioned downstream of the catalyst article and soot filter component.

18. The emission treatment system of claim 15, wherein the soot filter component comprises an SCR catalyst composition on a filter substrate, wherein the SCR catalyst composition comprises a metal ion-exchanged molecular sieve.

19. The emission treatment system of claim 14, wherein the engine is a diesel engine.

20. A method of making a catalyst article according to claim 1 comprising:
impregnating a refractory metal oxide support with a salt of a platinum component and a sulfur-containing component precursor to form an impregnated refractory metal oxide support;
calcining the impregnated refractory metal oxide support;
preparing a slurry by mixing the calcined impregnated refractory metal oxide support in an aqueous solution;
coating the slurry onto a substrate carrier; and
calcining the coated substrate carrier to obtain the catalyst article.

21. The method of claim 20, wherein the impregnating step comprises:
contacting the refractory metal oxide support with the salt of the platinum component and the sulfur-containing component precursor at the same time; or
contacting the refractory metal oxide support first with the salt of the platinum component followed by contact of the sulfur-containing component precursor; or
contacting the refractory metal oxide support first with the sulfur-containing component precursor followed by contact of the salt of the platinum component.

22. The method of claim 20, wherein the refractory metal oxide support is alumina and the sulfur-containing compound is selected from a group consisting of ammonium sulfate, iron sulfate, manganese sulfate, indium sulfate, ammonium sulfide, ammonium persulfate, tin sulfate, and combinations thereof.
